(19) United States
(12) Patent Application Publication
(10) Pub. No.: US 2007/0286183 A1
(43) Pub. Date: Dec. 13, 2007

(54) Resetting method for network switch device

(75) Inventors: Philip Crooks, Albans Hertfordshier (GB); James Freeman, Leighton Buzzard Bedfordshire (GB); David Kind, Albans Hertfordshire (GB); Iain Robertson Kenney, Hemel Hempstead Hertfordshire (GB)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/451,323

(22) Filed: Jun. 13, 2006

(51) Int. Cl. H04L 12/50

(52) U.S. Cl. 370/360

(57) ABSTRACT

A resetting method for a network switch device, which includes a plurality of connection ports, includes the following steps of: defining one of the connection ports as a transmitting port, defining another one of the connection ports as a receiving port, transmitting a resetting signal from the transmitting port to the receiving port, and resetting the network switch device when the receiving port receives the resetting signal.

### BACKGROUND OF THE INVENTION

1. Field of Invention

The invention relates to a resetting method and, in particular, to a resetting method for a network switch device.

2. Related Art

The prosperous development of Internet has carried out the network industry progress and the novel network communication apparatus is invented continually. In a local area network (LAN), the network switch is one of the necessary apparatuses for communicating multiple computers.

In general, a conventional network switch device has a resetting button, which is disposed on a casing of the network switch device. When a user presses the resetting button, the network switch device can be recovered to an initial setting, which is a factory setting. For example, as the user forgets the password, he or she is only to press the resetting button of the network switch device to recover it to the initial setting. Then, the user can reset the password. However, if the user touches the resetting button imprudently, the proper setting of the network switch device will disappear, resulting in troubles of the user.

It is therefore an important subject of the invention to provide a resetting method for the network switch device to avoid the user from touching the resetting button imprudently.

### SUMMARY OF THE INVENTION

In view of the foregoing, the invention is to provide a resetting method for a network, switch device to avoid the user from touching the resetting button imprudently.

To achieve the above, a resetting method for a network switch device of the invention includes the following steps, and the network switch device has a plurality of connection ports. First, one of the connection ports is determined as a transmitting port and another one of the connection ports is determined as a receiving port. Then, the transmitting port transmits a resetting signal to the receiving port. Finally, the network switch device is reset when the receiving port received the resetting signal.

As mentioned above, the resetting method for the network switch device of the invention resets the network switch device when the resetting signal is transmitted from the transmitting port and received by the receiving port. Therefore, it is unnecessary to dispose the resetting button on the casing of the network switch device, so that the user would not touch the resetting button imprudently. Besides, the cost of the resetting button can be saved so as to reduce the manufacture cost.

### BRIEF DESCRIPTION OF THE DRAWINGS

The invention will become more fully understood from the detailed description given herein below illustration only, and thus is not limitative of the present invention, and wherein:

FIG. 1 is an appearance diagram showing a network switch device according to an embodiment of the invention;

FIG. 2 is a schematic diagram showing an internal configuration of the network switch device according to the embodiment of the invention; and

FIG. 3 is a flow chart showing the resetting method for the network switch device according to the embodiment of the invention.

### DETAILED DESCRIPTION OF THE INVENTION

The resetting method for a network switch device of the invention will be apparent from the following detailed description.

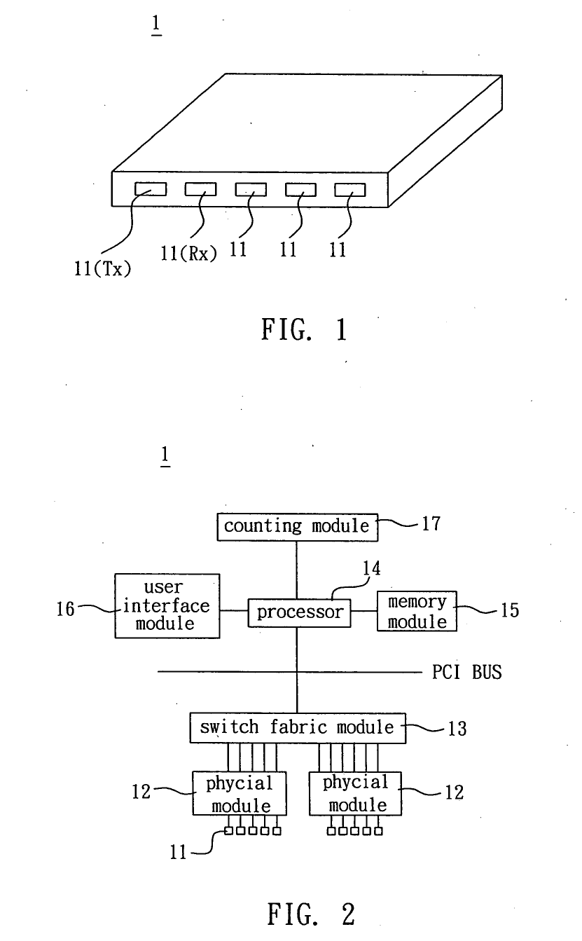

FIG. 1 and FIG. 2 are the appearance diagram and the internal configuration diagram of a network switch device cooperated with the resetting method according to an embodiment of the invention. In the embodiment, referring to FIG. 1 and FIG. 2, a network switch device 1 has a plurality of connection ports 11, a plurality of physical layer modules 12, a switch fabric module 13, a processor 14, a memory module 15, a user interface module 16, and a counting module 17.

In the embodiment, the connection ports 11 connect to the network system such as a local area network (LAN) or Internet. The connection ports 11 can be any suitable type of connector such as an RJ-45 connector.

In addition, the connection ports 11 connect to the switch fabric module 13 through the physical layer module 12, and the switch fabric module 13 connects to the processor 14 through a protocol control information bus (PCI Bus). The processor 14 is cooperated with the memory module 15 to perform an operation or a calculation. Furthermore, as shown in FIG. 1, one of the connection ports 11 is defined as a transmitting port Tx and another one of the connection ports 11 is defined as a receiving port Rx. In this embodiment, the transmitting port Tx is connected to the receiving port Rx by a network connection line such as an Ethernet line to form a virtual LAN (VLAN). In this case, the transmitting port Tx is to transmit a resetting signal and the receiving port Rx is to receive the resetting signal. The resetting signal is transmitted to the processor 14 to reset the network switch device when the receiving port Rx received the resetting signal. In the embodiment, the resetting signal transmitted from the transmitting port Tx to the receiving port Rx is a packet of the IEEE 802.3 standard.

Furthermore, the user can set a setting value such as a password of the network switch device 1 through the user interface module 16. The counting module 17 counts and records a number of times that the transmitting port Tx transmits the resetting signal transmitted for the following actions.

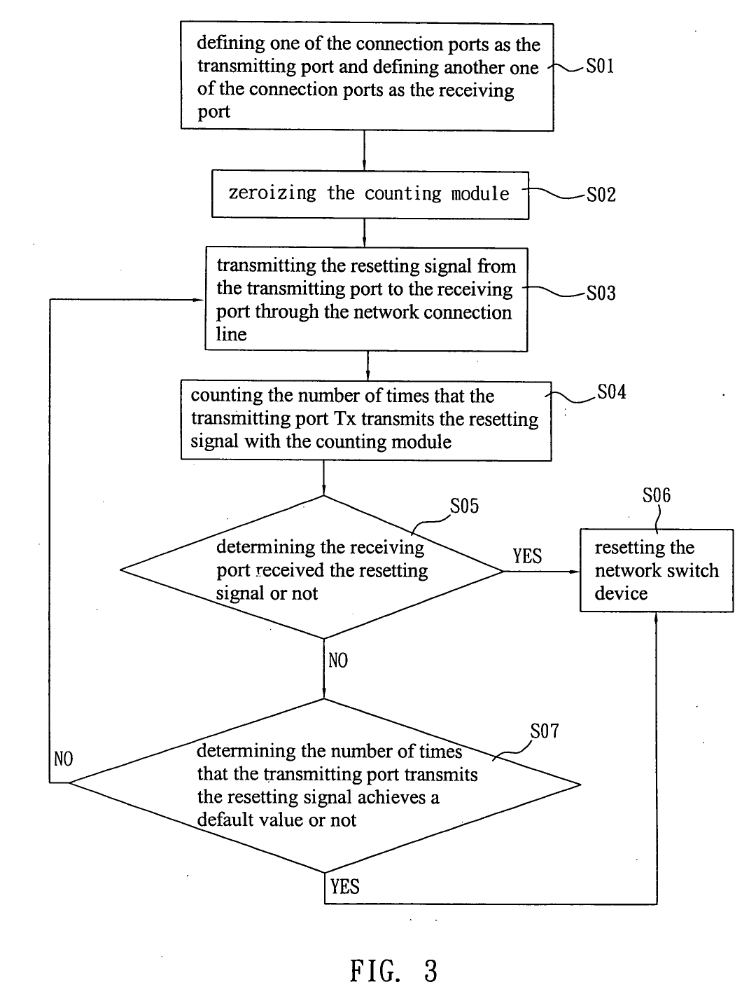

FIG. 3 is a flow chart showing the resetting method for the network switch device according to the embodiment of the invention. With reference to FIG. 3, the resetting method is cooperated with the network switch device 1 as mentioned above. The resetting method includes the following steps.

The step S01 is to define one of the connection ports 11 as the transmitting port Tx and define another one of the connection ports 11 as the receiving port Rx. In the embodiment, the transmitting port Tx is connected to the receiving port Rx by the network connection line to form the VLAN after the power of the network switch device 1 is turned off. Then, the power of the network switch device 1 is turned on for the following steps.

The step S02 is to zeroize the counting module 17 and then to begin counting.

The step S03 is to transmit the resetting signal from the transmitting port Tx to the receiving port Rx through the network connection line.

The step S04 is to count the number of times that the transmitting port Tx transmits the resetting signal with the counting module 17. The counting value of the counting module 17 is added by 1 while the resetting signal transmitted from the transmitting port Tx once.

The step S05 is to determine the receiving port Rx received the resetting signal or not. If the receiving port Rx received the resetting signal, the step S06 is then performed; otherwise, if not, the step S07 is performed.

The step S06 is to reset the network switch device 1 to recover it to the initial setting.

The step S07 is to determine the number of times that the transmitting port Tx transmits the resetting signal achieves a default value or not by measuring the counting value of the counting module 17. If the number of times achieves the default value, the step S03 is then performed; otherwise, if not, the step S06 is performed. In the embodiment, the default value can be set through the user interface module 16 or can be preset by the manufacturer.

In some cases, the step S07 can force the network switch device 1 to perform the reset action. For instance, when the counting value of the counting module 17 achieves the default value and the receiving port Rx can not receive the resetting signal from the transmitting port Tx due to the broken network connection line, the network switch device 1 is forced to perform the reset action. Accordingly, the network switch device 1 is reset.

In summary, the resetting method for the network switch device of the invention resets the network switch device when the resetting signal is transmitted from the transmitting port and received by the receiving port. Therefore, it is unnecessary to dispose the resetting button on the casing of the network switch device, so that the user would not touch the resetting button imprudently. Besides, the cost of the resetting button can be saved so as to reduce the manufacture cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A resetting method for a network switch device, wherein the network switch device has a plurality of connection ports, the resetting method comprising the following steps:
defining one of the connection ports as a transmitting port;
defining another one of the connection ports as a receiving port;
connecting the transmitting port with the receiving port;
transmitting a resetting signal from the transmitting port to the receiving port; and
resetting the network switch device when the receiving port receives the resetting signal.

2. The resetting method according to claim 1, further comprising the following steps:
recording a number of times that the transmitting port transmits the resetting signal;
determining the number of times reaches a default value or not; and
resetting the network switch device when the number of times reaches the default value.

3. The resetting method according to claim 2, wherein the step of recording the number of times that the transmitting port transmits the resetting signal is to record the number of times by a counting module.

4. The resetting method according to claim 2, wherein the default value is set with a user interface module.

5. The resetting method according to claim 1, wherein the transmitting port is connected to the receiving port with a network connection line.

6. The resetting method according to claim 5, wherein the network connection line is an Ethernet line.

7. The resetting method according to claim 5, wherein the transmitting port and the receiving port construct a virtual local area network (VLAN).

8. The resetting method according to claim 1, wherein the network switch device is an Ethernet switch device.

9. The resetting method according to claim 1, wherein the connection port is an RJ-45 terminal connection port.

10. The resetting method according to claim 1, wherein the resetting signal transmitted from the transmitting port to the receiving port is a packet.

11. The resetting method according to claim 10, wherein the packet is an IEEE 802.3 standard packet.
